(19) United States
(12) Patent Application Publication
(10) Pub. No.: US 2026/0225854 A1
(43) Pub. Date: Aug. 6, 2026

(54) PRE-ASSEMBLED UNITS IN MANUFACTURING FOR TEMPORTY SITES

(71) Applicant: Otis Elevator Company, Farmington, CT (US)

(72) Inventors: Arnaud Blanchard, Adon (FR); Gabriel Vaudour, Mardié (FR)

(21) Appl. No.: 19/402,396

(22) Filed: Nov. 26, 2025

(30) Foreign Application Priority Data
Feb. 5, 2025 (EP) 25305165.0

(51) Int. Cl. B66B 9/16; B66B 11/00; B66B 19/00

(52) U.S. Cl. CPC B66B 9/16; B66B 11/0005; B66B 19/00

(57) ABSTRACT

A transportable elevator system comprises a hoistway, an elevator car that is configured for moving along the hoistway and an elevator machine that is configured for driving the elevator car. The hoistway comprises a plurality of hoistway walls (24) with each of the hoistway walls (24) comprising a frame (24a) that surrounds a wall portion (24b, 24c) or that is surrounded by a wall portion (24b, 24c), and a plurality of reinforcement elements (26, 28a, 28b, 38) that are mounted to the hoistway walls (24), in particular to the wall portions (24b, 24c) and/or to the frames (24a) of the hoistway walls (24), such as to extend in a horizontal direction when the hoistway (4) is oriented in an upright position. The elevator car and the elevator machine are installed in the hoistway forming an integrated elevator system that is transportable to a desired installation site.

### FOREIGN PRIORITY

This application claims priority to European Patent Application No. 25305165.0, filed Feb. 5, 2025, and all the benefits accruing therefrom under 35 U.S.C. § 119, the contents of which in its entirety are herein incorporated by reference.

### TECHNICAL FIELD OF INVENTION

The invention relates to a transportable elevator system and to a method of installing a transportable elevator system at an installation site.

### BACKGROUND OF THE INVENTION

Elevator systems are widely utilized for transporting passengers and objects between different height levels, particularly between different floors within a building.

Elevator systems usually comprise a hoistway that is formed integrally with the building in which the respective elevator system is installed. The components of the elevator system, including, inter alia, an elevator car, an elevator machine for driving the elevator car, landing doors, control panels etc. are typically permanently installed in the building, usually within or close to the hoistway.

Consequently, a conventional elevator system is integrated into the building and cannot be relocated without being completely disassembled.

It may be beneficial to provide an improved elevator system that may be assembled, installed and relocated more easily.

### SUMMARY OF THE INVENTION

A transportable elevator system according to an exemplary embodiment of the invention comprises a hoistway, an elevator car that is configured for moving along the hoistway; and an elevator drive system that is configured for driving the elevator car. The hoistway comprises a plurality of hoistway walls comprising a frame that surrounds a wall portion or that is surrounded by a wall portion, and a plurality of reinforcement elements that are mounted to the hoistway walls, in particular to the wall portions and/or to the frames of the hoistway walls, such as to extend in a horizontal direction when the hoistway is oriented in an upright position. The elevator car and the elevator drive system are installed in the hoistway forming an integrated elevator system that is transportable as a single unit to an installation site, in particular to a temporary installation site, and/or for adding an elevator system to an existing building. The wall portion may be a board-like wall portion.

Exemplary embodiments of the invention further include a method of installing a transportable elevator system according to an exemplary embodiment of the invention, wherein the method includes: assembling the transportable elevator system, in particular in a factory; transporting the transportable elevator system as a single unit to an installation site in a basically horizontal orientation; erecting the transportable elevator system at the installation site into a vertical orientation; and mechanically coupling the transportable elevator system with a building at the installation site.

A transportable elevator system according to an exemplary embodiment of the invention may be assembled very efficiently in a factory, forming an integrated unit that may be transported to and installed at an installation site, in particular to a temporary installation site. A transportable elevator system according to an exemplary embodiment of the invention may also be detached easily from the building at which it is installed and transported to a new installation site. A transportable elevator system according to an exemplary embodiment of the invention may further be used for retrofitting an elevatorless building with an elevator system.

Forming the hoistway walls with a frame that surrounds a wall portion or that is surrounded by a wall portion and mounting a plurality of reinforcement elements to the hoistway walls such as to extend in a horizontal direction when the hoistway is oriented in an upright position provides hoistway walls that have a low weight, in particular a weight that is low enough in order to allow for transporting the complete elevator system as an integrated unit to the site of installation. At the same time, the hoistway walls of a transportable elevator system according to an exemplary embodiment of the invention are rigid and strong enough for withstanding the mechanical loads that are exerted on them when the elevator system is installed and operated.

A transportable elevator system according to an exemplary embodiment of the invention may be efficiently employed at different locations and in combination with different buildings. A transportable elevator system according to an exemplary embodiment of the invention may in particular be employed in combination with mobile and/or temporary buildings, such as container buildings, which are designed for temporary use.

In the following, a number of further optional features of a transportable elevator system according to exemplary embodiments of the invention are set out. These features may be realized in particular embodiments, alone or in combination with any of the other features, unless explicitly stated otherwise.

A transportable elevator system according to an exemplary embodiment of the invention may comprise a counterweight that is configured for moving simultaneously and concurrently with the elevator car. Providing a counterweight may reduce the forces that are needed for moving the elevator car upwards. The elevator system may further comprise at least one counterweight guide rail that is configured for guiding the counterweight along the hoistway.

The frames of the hoistway walls may be made from a different material than the wall portions. The frames may in particular be made from a rigid material for providing the necessary strength. In order to reduce the weight of the hoistway walls, the wall portions may be made at least partially from a material that is lighter than the material used for the frames.

The wall portions may be at least partially made of metal, in particular of corrugated metal, or of a synthetic material, in particular of a transparent and/or decorative synthetic material, such as acrylic glass. The wall portions may also be made of wood.

Mounting a plurality of reinforcement elements to the hoistway walls such as to extend in a horizontal direction when the hoistway is oriented in an upright position allows for providing hoistway walls that are rigid and strong enough for withstanding the mechanical loads that are exerted on them when the elevator system is installed and operated, and which have a low weight, in particular a weight that is low enough in order to allow for transporting the complete elevator system as an integrated unit to the site of installation.

The wall portion may have an internal structure that enhances the stability of the wall portion. The wall portion may in particular comprise an inner wall facing the interior of the hoistway, an outer wall facing to the outside of the hoistway, and at least one stabilizing structure that is arranged between the inner wall and the outer wall.

The at least one stabilizing structure may, for example, comprise at least one stabilizing element extending perpendicularly to the inner wall and to the outer wall.

The at least one stabilizing structure may include at least one undulated element that alternately abuts against the inner wall and the outer wall.

Such stabilizing structures allow for providing wall portions having a high mechanical strength and a low weight.

The reinforcement elements may comprise at least one inner reinforcement element that is located on a side of a hoistway wall facing the hoistway and at least one corresponding outer reinforcement element that is located on an opposite side of the hoistway wall facing the exterior of the hoistway and configured for supporting the at least one corresponding inner reinforcement element. The at least one outer reinforcement element may in particular be mounted to and supported by the frame of the hoistway wall. Providing the hoistway will with at least one outer reinforcement element allows for reducing the weight of the wall portion even further, since the wall portion does not need to be strong enough for supporting the inner reinforcement element.

The elevator machine may be arranged on a bedplate that is supported by at least one of the reinforcement elements, in particular by at least one reinforcement element that is located adjacent to the top of the hoistway.

The plurality of reinforcement elements may comprise at least one reinforcement element that is formed integrally with one of the corrugated sheet metal profiles for permanently increasing the mechanical strength and rigidity of the hoistway walls. Forming at least one reinforcement elements integrally with one of the corrugated sheet metal profiles facilitates the assembly of the elevator system since the at least one reinforcement element does not need to be mounted to the corrugated sheet metal profile.

The plurality of reinforcement elements may comprise at least one reinforcement element that is mounted to at least one of the corrugated sheet metal profiles, the at least one reinforcement element may in particular be removably mounted to at least one of the corrugated sheet metal profiles.

A removably mounted reinforcement element may be mounted to at least one of the hoistway walls only temporarily, in particular only during the transport of the elevator system, for temporarily supporting and/or fixing the elevator car and/or the counterweight of the elevator system. Such removably mounted reinforcement elements may allow for transporting the elevator system without damaging the elevator car, the counterweight and/or the hoistway due to uncontrolled movements of the elevator car and/or the counterweight in the hoistway during the transport.

The transportable elevator system may further comprise at least one securing element that is mounted to at least one of the reinforcement elements and that is configured for supporting and/or for securing the elevator car and/or the counterweight in the hoistway, in particular when the hoistway is oriented horizontally for transportation. Securing the elevator car and/or the counterweight in the hoistway may in particular include fixing the elevator car in the hoistway for preventing movement of the elevator car. Providing at least one securing element may reduce the risk of damaging components of the transportable elevator system in the course of transportation even further.

The at least one securing element may be configured for being removed after the elevator car has been installed at the installation site, when there is no need for further supporting the elevator car and/or the counterweight.

A method of installing a transportable elevator system according to an exemplary embodiment of the invention may include removing the at least one securing element from the hoistway after the hoistway has been erected into a horizontal orientation at the installation site.

The at least one securing element may be mounted to at least one of the inner reinforcement elements, in particular to one of the inner removable reinforcement elements. The reinforcement elements may provide strong anchor points for supporting and mounting the at least one securing element in the hoistway.

The hoistway of a transportable elevator system according to an exemplary embodiment of the invention may be formed from a plurality of hoistway modules that are stacked vertically on top of each other. Forming the hoistway of the transportable elevator system form a plurality of hoistway modules allows for conveniently manufacturing transportable elevator systems having different heights. In other words, the height of the transportable elevator system may be adjusted easily to match the height of the building where it is to be installed.

In order to provide a mechanically strong hoistway, adjacent hoistway modules may be mechanically coupled with each other using coupling structures. The coupling structures may in particular be formed adjacent to the interfaces between adjacent hoistway modules.

The coupling structures may include reinforcement elements that are mounted to or formed integrally with the hoistway walls. The coupling structures may include bolts or screws that are configured for mechanically coupling the reinforcement elements of adjacent hoistway modules with each other.

All hoistway modules may have the same height when arranged in an upright position. Hoistway modules having the same height may be manufactured cost-efficiently in large numbers.

The hoistway modules may have heights in the range of between 2.5 m and 3.0 m, in particular heights the range of between 2.6 m and 2.7 m. Heights in the range of between 2.5 m and 3.0 m, in particular heights the range of between 2.6 m and 2.7 m, correspond to the typical heights of the floors of a building. Consequently, hoistway modules having heights in the range of between 2.5 m and 3.0 m, in particular heights the range of between 2.6 m and 2.7 m, correspond to the typical height of floors of a building. This correspondence facilitates the installation of transportable elevator systems according to exemplary embodiments of the invention in a building. Depending on the dimensions of the building for which the elevator system is intended to be used, the individual hoistway modules may have heights that are smaller than 2.5 m or heights that are larger than 3.0 m.

Optionally, a transportable elevator system according to an exemplary embodiment of the invention may comprise a dedicated elevator drive module housing the elevator machine. Such a dedicated elevator drive module may have a different height, in particular a smaller height, than the other hoistway modules.

Providing a dedicated elevator drive module allows the other hoistway modules that correspond to the different floors of the building to be identical since none of the hoistway modules needs for be configured for housing and supporting the elevator machine. This may reduce the costs for manufacturing and assembling the transportable elevator system even further.

The total height of the hoistway, when arranged in an upright position, may be limited to 13.2 m in order to allow for transporting the complete transportable elevator system to the installation site on a truck or trailer. Depending on the equipment used for transporting the elevator system, the total height of the hoistway may be more or less than 13.2 m.

A transportable elevator system according to an exemplary embodiment of the invention comprises a plurality of landing doors, in particular at least one landing door at each of the landings.

All landing doors of the transportable elevator system may be formed on the same side of the hoistway, in particular on the side of the hoistway that faces the building when the transportable elevator system is installed at a building.

Alternatively, at least one of the landing doors, in particular the landing door at the lowermost landing, may be formed on a different side of the hoistway than the other landing doors. Such a configuration may allow passengers to directly enter and leave the elevator car from/to the outside without entering and walking through the building. This may allow for a more efficient use of the transportable elevator system.

The at least one landing door may be formed in a wall of the hoistway that is opposite to the side of the hoistway facing the building. The at least one landing door may also be formed in a wall of the hoistway that is oriented perpendicularly to the side of the hoistway facing the building.

It is also possible that the lowermost landing comprises at least two landing doors, for example a first landing door facing the building and at least one second landing door that provides access to the elevator car from outside the building.

Exemplary embodiments of the invention further include a mobile building that is equipped with a transportable elevator system according to an exemplary embodiment of the invention in order to allow conveying people and objects between different floor of the mobile building. Such a mobile building may be assembled from a plurality of containers with at least two of the plurality of containers being stacked vertically on top of each other.

Exemplary embodiments of the invention further include the use of a transportable elevator system according to an exemplary embodiment of the invention for conveying people and objects between different floor of a mobile building. The mobile building may be assembled from a plurality of containers with at least two of the plurality of containers being stacked vertically on top of each other.

Transportable elevator systems according to exemplary embodiments of the invention allow for efficiently equipping mobile buildings, such as mobile building made of containers, with an elevator system for facilitating access to the upper floors of such mobile buildings. Transportable elevator systems according to exemplary embodiments of the invention may be separated easily from the mobile building for being reused at another site when the mobile building is dismantled.

### BRIEF DESCRIPTION OF THE DRAWINGS

In the following, exemplary embodiments of the invention are described in more detail with respect to the enclosed figures:

FIG. 1 depicts a schematic view of an elevator system.

FIG. 2 depicts a perspective view of an hoistway of a transportable elevator system according to an exemplary embodiment of the invention form a first side.

FIG. 3 depicts the hoistway 4 shown in FIG. 2 from an opposite side with two of the hoistway walls being removed.

FIG. 4 shows an enlarged view of an elevator machine and a support structure supporting the elevator machine in the hoistway of a transportable elevator system according to an exemplary embodiment of the invention.

FIG. 5 depicts an enlarged view of a coupling structure between two adjacent hoistway modules.

FIG. 6 depicts a hoistway module comprising a hoistway wall according to another exemplary embodiment of the invention.

FIG. 7 depicts yet another exemplary embodiment of a hoistway module.

FIG. 8 depicts an enlarged view of a hoistway wall comprising a wall panel and an outer reinforcement element.

FIG. 9A depicts a perspective view of a section through two adjacent hoistway walls of a hoistway module according to yet another exemplary embodiment of the invention.

FIG. 9B depicts a plan view of a section through one of the hoistway walls depicted in FIG. 9A.

FIG. 10A depicts a perspective view of a section through adjacent hoistway walls of a hoistway module according to yet another exemplary embodiment of the invention.

FIG. 10B depicts a plan view of a section through one of the hoistway walls depicted in FIG. 10A.

FIG. 11 depicts a schematic view of an alternative embodiment of a transportable elevator system according to an exemplary embodiment of the invention.

FIG. 12 depicts a building that is equipped with a transportable elevator system according to an exemplary embodiment of the invention.

### DETAILED DESCRIPTION OF THE INVENTION

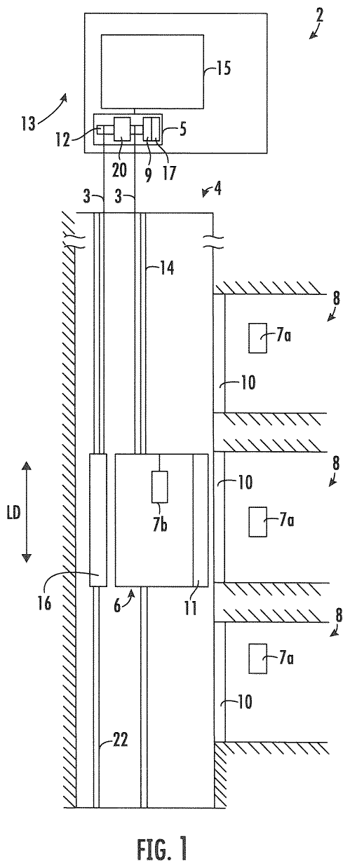

FIG. 1 schematically depicts an elevator system 2. In the following, the general structure and operation of an elevator system 2 are described with reference to FIG. 1.

The elevator system 2 comprises a hoistway 4 extending in a longitudinal direction LD between a plurality of landings 8 located on different floors. The elevator system 2 includes an elevator car 6 that is arranged in the hoistway 4 for being moved along the longitudinal direction LD between the plurality of landings 8. The elevator car 6 may in particular be movable along at least one elevator car guide rail 14, provided in the hoistway 4 and extending along the longitudinal direction LD.

The longitudinal direction LD may be oriented in a vertical direction, as it is depicted in FIG. 1. In an alternative embodiment that is not depicted in the figures, the longitudinal direction LD may be inclined with respect to the vertical direction.

Although only a single elevator car guide rail 14 is depicted in FIG. 1, the elevator system 2 may comprise a plurality of elevator car guide rails 14 extending parallel to each other.

Although only a single elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a tension member 3. Although only a single tension member 3 is depicted in FIG. 1, exemplary embodiments of the invention may also include elevator systems 2 comprising a plurality of tension members 3.

The at least one tension member 3, for example a rope or belt, is coupled to an elevator drive system 5. The elevator drive system 5 comprises an elevator machine 9 for rotatably driving a shaft 12, and a drive 17 that harnesses and controls the electrical energy supplied to the elevator machine 9. The elevator drive system 5 is configured for driving the at least one tension member 3, which is coupled to the shaft 12 via traction, in order to move the elevator car 6 in the hoistway 4 along the longitudinal direction LD between the plurality of landings 8.

The elevator drive system 5 is further provided with at least one elevator brake 20 for braking rotation of the shaft 12 in order to allow for stopping movement of the elevator car 6 and holding the elevator car 6 at a desired position in the hoistway 4.

Optionally, the elevator system 2 may comprise a counterweight 16. The counterweight 16 may be attached to the at least one tension member 3 opposite to the elevator car 6 and configured for moving concurrently and in opposite direction with respect to the elevator car 6. The counterweight 16 may move along at least one counterweight guide rail 22 provided in the hoistway 4 and extending along the longitudinal direction LD.

The at least one tension member 3 may be a rope, e.g. a steel cord, or a belt, in particular a coated steel belt. The at least one tension member 3 may be uncoated. Alternatively, the at least one tension member 3 may be coated with a coating, e.g. with a coating having the form of a polymer jacket. In a particular embodiment, the at least one tension member 3 may be a belt comprising a plurality of polymer coated steel cords (not shown). The elevator system 2 may have a traction drive including a traction sheave for driving the at least one tension member 3.

In the exemplary embodiment shown in FIG. 1, a 1:1 roping is employed for suspending the elevator car 6. The type of the roping is, however, not essential for the invention and different kinds of roping, e.g. a 2:1 roping or a 4:1 roping may be employed as well. In an alternative embodiment that is not explicitly depicted in the figures, the elevator system 2 may be a hydraulic elevator system 2 comprising a hydraulic drive system for moving the elevator car 6 along the hoistway 4.

A landing door 10 is optionally provided at each of the landings 8. In some embodiments, not all landings 8 may have a landing door 10. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by an elevator controller 15 of the elevator system 2.

The elevator system 2 may be a machine room-less elevator system 2. In an alternative embodiment, the elevator system 2 may comprise a machine room 13 housing the elevator drive system 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled with the elevator controller 15 by means of electrical wiring not shown in FIG. 1, in particular by an electric bus, or by wireless data connections.

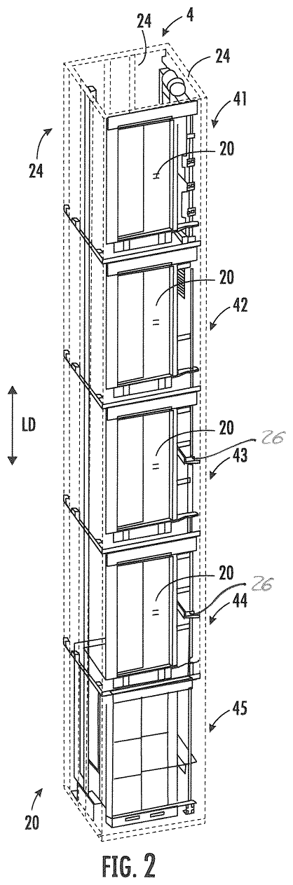

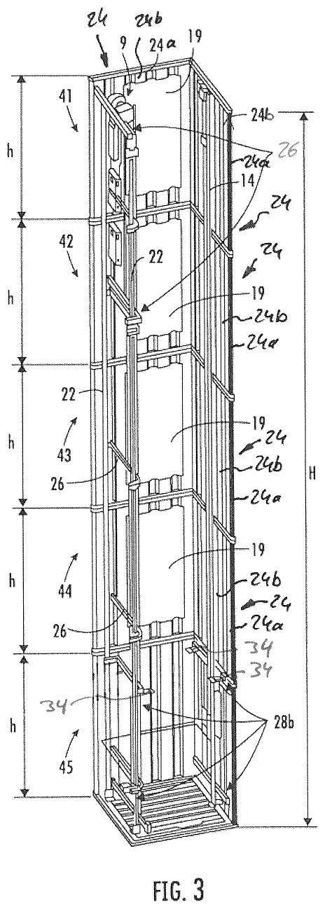

FIG. 2 depicts a perspective view of a hoistway 4 of a transportable elevator system 2 according to an exemplary embodiment of the invention form a first side, for example a rear side. FIG. 3 depicts the hoistway 4 shown in FIG. 2 from an opposite side, which may be a front side of the transportable elevator system 2. In FIG. 3 two of the hoistway walls 24 have been removed for allowing an unobstructed view into the hoistway 4.

In the exemplary embodiment depicted in FIGS. 2 and 3, the landing door 10 at the lowermost landing 8 is formed on the rear side of the hoistway 4, and the landing doors 10 provided at the other (upper) landings 8 are formed on the opposite front side of the hoistway 4. In FIG. 3, only the openings 19 for accommodating the landing doors 10 are shown.

In further embodiments, which are not explicitly depicted in the enclosed figures, all landing doors 10 may be formed on the same side of the hoistway 4.

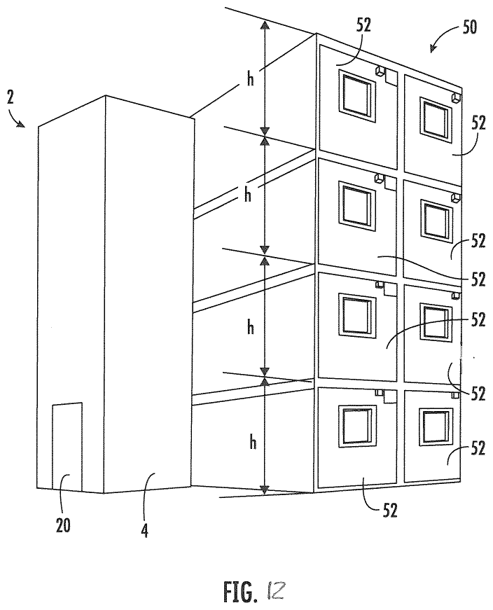

Alternatively, at least one of the landing doors 10 may be formed in a wall 24 of the hoistway 4 that is oriented perpendicularly to the wall 24 of the hoistway 4 in which the other landing doors 10 are formed. An example of such an embodiment is depicted in FIG. 11, which will be discussed in more detail below.

Each of the walls 24 of the hoistway 4, which also may be denoted as “hoistway walls 24”, comprises a frame 24a and a wall portion 24b that is surrounded by the frame 24b. In further embodiments, which are nor explicitly depicted in the figures, the frame 24a may by surround by the wall portion 24b.

In the exemplary embodiment depicted in FIG. 3, the wall portions 24b are formed from corrugated profiles, in particular from corrugated sheet metal profiles. The ribs and grooves of the corrugation extend along the longitudinal direction LD of the hoistway 4.

In further embodiments, the wall portions 24b may have other structures and/or may be formed from different materials. Examples of such alternative embodiments will be discussed further below with reference to FIGS. 6 to 8.

The hoistway 4 is further equipped with a plurality of reinforcement elements 26, 28a, 28b. The reinforcement elements 26, 28a, 28b are mounted to the hoistway walls 24 such as to extend perpendicularly to the longitudinal direction LD.

The reinforcement elements 26, 28a, 28b depicted in FIG. 3 are inner reinforcement elements 26, 28a, 28b that are attached to an inner sides of the hoistway walls 24 facing the interior of the hoistway 4. Corresponding outer reinforcement elements 29, which are not depicted in FIG. 3, may be provided on the opposite outsides of the hoistway walls 24. The outer reinforcement elements 29 may in particular be arranged at the same height as the inner reinforcement elements 26, 28a, 28b. The outer reinforcement elements 29 may be mechanically coupled with the inner reinforcement elements 26, 28a, 28b for supporting the inner reinforcement elements 26, 28a, 28b.

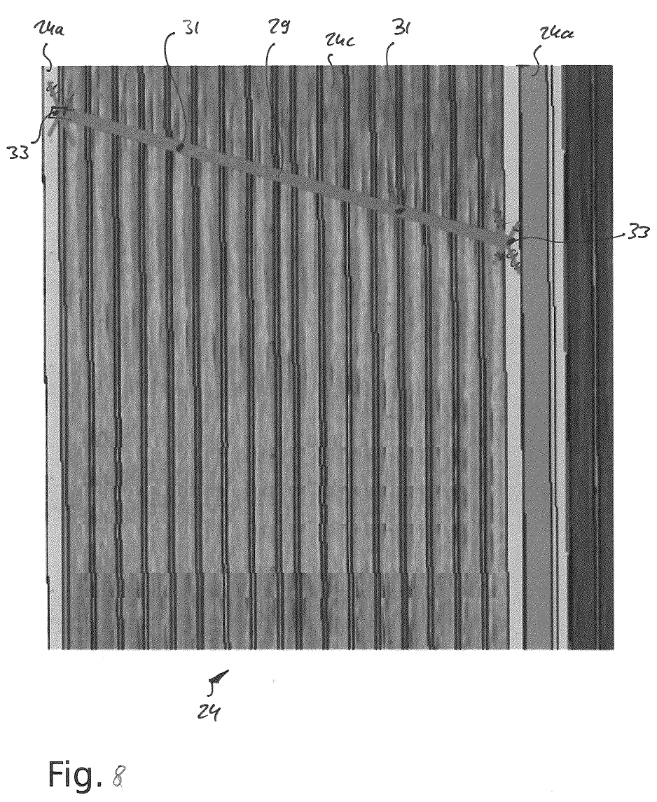

An exemplary embodiment of an outer reinforcement element 29 is depicted in FIG. 8, which will be discussed further below.

FIGS. 2 and 3 further shown an elevator machine 9 that is provided in the hoistway 4 for driving the elevator car 6. The elevator machine 9 is supported by one of the reinforcement elements 28a located in the vicinity of the top of the hoistway 4.

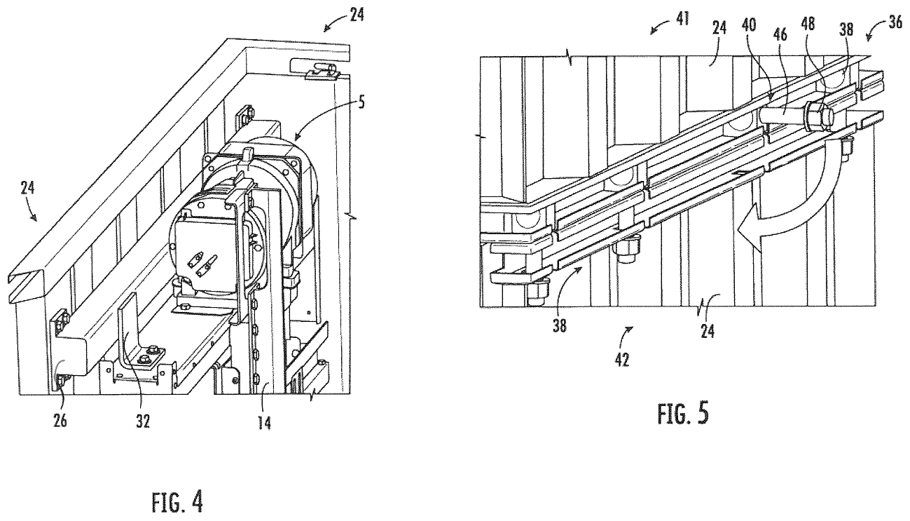

FIG. 4 shows an enlarged view of the elevator machine 9 and a support structure supporting the elevator machine 9.

The support structure includes a bedplate 30 that is mounted to a reinforcement element 26 by L-shaped connectors 32. The elevator machine 9 is arranged on said bedplate 30.

FIG. 4 further shows an upper end of an elevator car guide rail 14 that is mounted to the elevator machine 9 and to the bedplate 30.

Referring again to FIGS. 2 and 3, the elevator system 2 further comprises removable reinforcement elements 28a, 28b, which are temporarily installed in the hoistway 4 for supporting the elevator car 6 and the counterweight 16 when the elevator system 2 is transported.

The elevator system 2 comprises in particular two removable counterweight reinforcement elements 28a that are provided in an upper portion of the hoistway 4 for supporting the counterweight 16, when it its arranged in a transport position in the vicinity of the upper end of the hoistway 4. The elevator system 2 further comprises four removable car reinforcement elements 28b that are provided in a lower portion of the hoistway 4 for supporting the elevator car 6, when it its arranged in a transport position in the vicinity of the lower end of the hoistway 4.

The number of reinforcement elements 26, 28a, 28b depicted in FIG. 3 is only an example. Further exemplary embodiments that or not explicitly depicted in the figures may comprise different numbers of reinforcement elements 26, 28a, 28b.

The removable reinforcement elements 28a, 28b are in particular configured for supporting the elevator car 6 and the counterweight 16 when the hoistway 4 is oriented horizontally, for example for being transported on a truck or trailer.

The removable reinforcement elements 28a, 28b extend perpendicularly to the longitudinal direction LD. The removable reinforcement elements 28a, 28b are removably mounted to the hoistway walls 24, for example by screws or clamps, which are not depicted in FIGS. 2 and 3.

The removable reinforcement elements 28a, 28b are equipped with securing elements 34, such as screws or clamps. The securing elements 34 are configured for being mechanically coupled to the elevator car 6 or to the counterweight 16, respectively, for securing the elevator car 6 and the counterweight 16 in their respective transport position in the hoistway 4.

After the hoistway 4 has been erected into a vertical orientation at the site of installation and prior to operating the elevator system 2 for the first time, the securing elements 34 and the removable reinforcement elements 28a, 28b are removed from the hoistway 4 in order to allow the elevator car 6 and the counterweight 16 to move freely in the hoistway 4 along the longitudinal direction LD.

In the exemplary embodiment depicted in FIGS. 2 and 3, the hoistway 4 is assembled from a plurality of hoistway modules 41-45 that are stacked vertically on top of each other. Adjacent hoistway modules 41-45 are mechanically coupled with each other by coupling structures 36 that are formed at the interfaces between adjacent hoistway modules 41-45.

FIG. 5 depicts an enlarged view of such a coupling structure 36 provided at an interface between two adjacent hoistway modules 41, 42.

The coupling structure 36 depicted in FIG. 5 includes two reinforcement elements 38 in the form of bars that are formed at the upper and lower ends of the walls 24 of the two hoistway modules 41, 42. The two reinforcement elements 38 extend parallel to each other perpendicularly to the longitudinal direction LD.

The reinforcement elements 38 may be formed integrally with the walls 24 of the hoistway modules 41-45, as it is depicted in FIG. 5. In alternative embodiments, which are not explicitly depicted in the figures, the reinforcement elements 38 may be formed separately from and mounted to the walls 24 of the hoistway modules 41-45, e.g. by welding and/or using bolts and/or screws.

The coupling structure 36 further comprises coupling elements 40 that are configured for securely coupling the two adjacent reinforcement elements 38 with each other.

FIG. 5 depicts an example of a coupling element 40 including a bolt 46, in particular a threaded bolt 46, that is configured to extend between the two adjacent reinforcement elements 38.

The bolt 46 is provided with an external thread. The coupling element 40 further includes a nut 48 that is screwed onto the bolt 46 for securing the bolt 46 in a coupling configuration, in which the bolt 46 extends along the longitudinal direction LD between the two adjacent reinforcement elements 38 and securely fixes the two reinforcement elements 38 to each other.

Although only a single coupling element 40 is depicted in FIG. 5, a plurality of coupling elements 40 may be provided at each interface between adjacent hoistway modules 41-45 for securely fastening the adjacent hoistway modules 41-45 pairwise to each other.

In the exemplary embodiment depicted in FIGS. 2 and 3, all hoistway modules 41-45 have the same height h along the longitudinal direction LD. Each of the hoistway modules 41-45 may in particular have a height h in the range of between 2.5 m and 3.0 m, more particular a height h in the range of between 2.6 m and 2.7 m. Depending on the dimensions of the building for which the elevator system is intended to be used, the hoistway modules 41 may have heights h that are smaller than 2.5 m or heights h that are larger than 3.0 m.

According to an exemplary embodiment of the invention, the total height H of the hoistway 4 does not exceed 13.2 m in order to allow for transporting the complete transportable elevator system 2 with a single truck or trailer. The hoistway 4 may be arranged in a horizontal orientation on the truck or trailer. Depending on the equipment used for transporting the transportable elevator system 2, the total height H of the hoistway 4 may be more or less than 13.2 m.

FIG. 6 depicts a hoistway module 41 comprising a hoistway wall 24 according to another exemplary embodiment of the invention.

In the embodiment depicted in FIG. 6, the hoistway wall 24 comprises three rectangular frames 24a that are formed adjacent to each other along the horizontal direction. A wall panel 24c is arranged in each of the frames 24a, respectively. The number of three rectangular frames 24a and three wall panels 24c depicted in FIG. 6 is only an example. In further embodiments that are not explicitly depicted in the figures, a hoistway wall 24 according to an exemplary embodiment as it is depicted in FIG. 6 may comprise more or fewer than three rectangular frames 24a and more or fewer than three wall panels 24c, respectively.

The wall panels 24c may be made of metal or of a synthetic material. The wall panels 24c may in particular be made of a transparent and/or decorative synthetic material, such as acrylic glass.

For enhancing the mechanical characteristics of the hoistway wall 24, adjacent wall panels 24c may be fixed to each other using fixing means that are not depicted in FIG. 6.

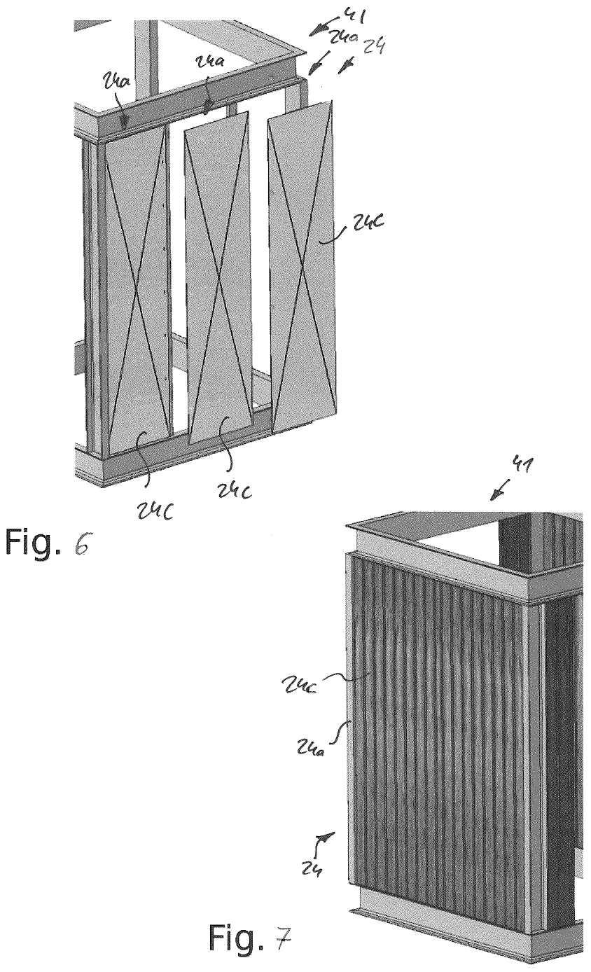

FIG. 7 depicts a hoistway module 41 according to a further exemplary embodiment of the invention. In the exemplary embodiment depicted in FIG. 7, the wall panel 24c is made of wood. In the exemplary embodiment depicted in FIG. 1, the hoistway wall 24 comprises only a single wall panel 24b. This is only an example. A hoistway wall 24 according to an exemplary embodiment as it is depicted in FIG. 7 may comprise more than a single wall panel 24b made of wood.

FIG. 8 depicts an enlarged view of a hoistway wall 24 comprising a wall panel 24b made of wood, as it is depicted in FIG. 7, in combination with an outer reinforcement element 29. The outer reinforcement element 29 extends between two vertically extending beams of the frame 24a. Although only a single outer reinforcement element 29 is exemplary depicted in FIG. 8, a hoistway wall 24 according to an exemplary embodiment of the invention may be equipped with a plurality of reinforcement element 29. The reinforcement elements 29 may, in particular, be arranged a different heights of the hoistway wall 24.

Reinforcement elements 29 may also be used in combination with other types of hoistway walls 24, in particular in combination with hoistway walls 24 comprising wall panels 24b made of metal and/or synthetic materials, as depicted in FIGS. 3 to 6.

The outer reinforcement element(s) 29 may be made of metal or of a synthetic material.

The outer reinforcement element(s) 29 may be made of an elastic material. Outer reinforcement elements 29 made of an elastic material may be mounted to the frame 24a in an extended configuration for applying a horizontal tension force to the vertically extending beams of the frame 24a. Applying tension forces to the vertically extending beams of the frame 24a may improve the mechanical characteristics of the hoistway wall 24.

The outer reinforcement element(s) 29 may be securely fixed to the vertically extending beams of the frame 24a using fixing elements 33, such as bolts, rivets or screws. The outer reinforcement element(s) 29 may also be fixed to the vertically extending beams of the frame 24a by gluing, soldering or welding.

The outer reinforcement element(s) 29 may in particular be arranged at the same height as corresponding inner reinforcement elements 26, 28a, 28b that are arranged on the opposite, inner side of the hoistway wall 24. An inner reinforcement element 26, 28a, 28b is not visible in FIG. 8 since it is covered by the non-transparent wall panel 24c.

The outer reinforcement element 29 and a corresponding inner reinforcement element 26, 28a, 28b may be mechanically coupled with each other by fixing means 31, such as bolts, rivets or screws, extending though the wall panel 24c so that the outer reinforcement element 29 supports the inner reinforcement element 26, 28a, 28b.

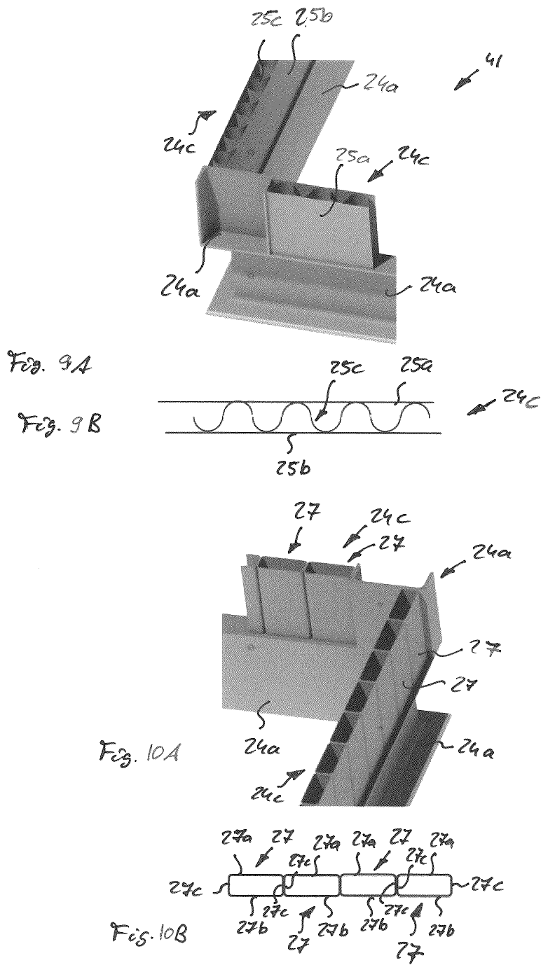

FIG. 9A depicts a perspective view of a cross-section through adjacent hoistway walls 24 of a hoistway module 41 according to yet another exemplary embodiment of the invention. FIG. 9B depicts a plan view of a cross-section through one of the hoistway walls 24 depicted in FIG. 9A.

Each of the hoistway walls 24 depicted in FIGS. 9A and 9B comprises a wall panel 24c arranged in and supported by a frame 24a. Only a portion of the wall panel 24c and of the frame 24a are shown in FIGS. 9A and 9B.

Each wall panel 24c comprises an inner wall 25a facing the interior of the hoistway 4 and an outer wall 25b facing to the exterior of the hoistway 4. Each wall panel 24c further comprises a stabilizing structure 25c that is arranged between the inner wall 25a and the outer wall 25b of the respective wall panel 24c for enhancing the mechanical characteristics of the wall panel 24c.

In the exemplary embodiment depicted in FIGS. 9A and 9B, the stabilizing structure 25c is provided in the form of an undulated element that is arranged between the inner wall 25a and the outer wall 25b of wall panel 24c such that the crests of the undulated element alternately abut against the inner wall 25a and against the outer wall 25b of wall panel 24c, respectively.

Optionally, the crests of the stabilizing structure 25c may be fixed to the inner wall 25a and/or to the outer wall 25b of wall panel 24c, e.g. by gluing, soldering or welding, or by fixing elements such as bolts, rivets or screws.

The inner wall 25a, the outer wall 25b and the stabilizing structure 25c may be made from the same material. Alternatively, the stabilizing structure 25c may be made from another material than the inner and outer walls 25a, 25b.

The inner wall 25a, the outer wall 25b may be made from metal, in particular from steel, such as hot profiled steel or cold profiled steel, or from aluminum.

Alternatively, the inner wall 25a, the outer wall 25b may be made from a synthetic material, such as fiberglass or carbon fiber.

The stabilizing structure 25c may be made of steel, a synthetic material or of cardboard.

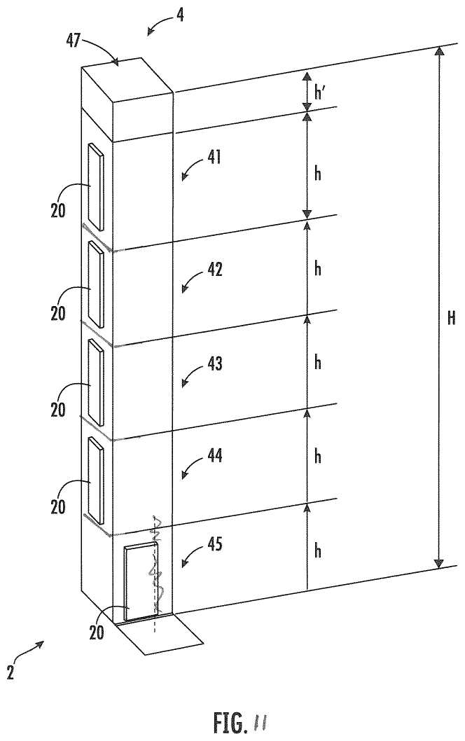

FIG. 10A depicts a perspective view of a cross-section through two adjacent hoistway walls 24 of a hoistway module 41 according to yet another exemplary embodiment of the invention. FIG. 10B depicts a plan view of a cross-section through one of the hoistway walls 24 depicted in FIG. 10A.

Each of the hoistway walls 24 depicted in FIGS. 10A and 10B comprises a wall panel 24c that is arranged in and supported by a frame 24a. Only a portion of the wall panel 24c and of the frame 24a are depicted in FIGS. 10A and 10B.

The wall panel 24c depicted in FIGS. 10A and 10B comprises a plurality of wall profiles 27 that are arranged adjacent to each other along the horizontal direction. The wall profiles 27 extend parallel to each other, in particular along the longitudinal direction LD.

The cross-section of each of the wall profiles 27 depicted in FIGS. 10A and 10B has a rectangular shape, comprising two longs sides 27a, 27b forming the inner and outer sides of the wall panel 24c, and two short sides 27c extending perpendicularly to the long sides 27a, 27b between the inner and outer sides of the wall panel 24c.

The short sides 27b of adjacent wall profiles 27 may be fixed to each other, e.g. by gluing, soldering or welding.

The rectangular cross-sections of the wall profiles 27 depicted in FIGS. 10A and 10B are only exemplary. In further embodiments, the wall profiles 27 may have quadratic cross-sections or cross-sections that are rotated by 90°, i.e. cross-sections in which the long sides 27a, 27b short sides 27c are interchanged with each other.

The wall profiles 27 may be made from metal, in particular from steel, such as hot profiled steel and cold profiled steel, or from aluminum. The wall profiles 27 may be formed by extruding the metal or by folding a sheet of metal.

Alternatively, the wall profiles 27 may be made from a synthetic material, such as fiberglass or carbon fiber. The wall profiles 27 may in particular be formed by extruding the synthetic material or be injection molding.

FIG. 11 depicts a schematic view of an alternative embodiment of a transportable elevator system 2 according to an exemplary embodiment of the invention.

In the exemplary embodiment depicted in FIG. 11, the elevator system 2 comprises a plurality of hoistway modules 41-45 and a dedicated elevator drive module 47 that houses the elevator machine 9. The elevator drive module 47 may have a smaller height h′ than to the other hoistway modules 41-45.

Providing a dedicated elevator drive module 47 allows the other hoistway modules 41-45 to be identical since none of the hoistway modules 41-45 needs for be configured for housing and supporting the elevator machine 9. This may reduce the costs for manufacturing and assembling the transportable elevator system 2 even further.

FIG. 12 depicts a building 50 that is equipped with a transportable elevator system 2 according to an exemplary embodiment of the invention.

The building 50 may be a mobile building 50, in particular a building 50 that is assembled from a plurality of mobile containers 52.

A transportable elevator system 2 according to an exemplary embodiment of the invention is positioned adjacent to one side of the building 50. The transportable elevator system 2 is in particular positioned such that the landing doors 10 of the transportable elevator system 2 align with corresponding floors of the building 50. The hoistway 4 may be mechanically coupled to the adjacent containers 52 by mechanical coupling elements that are not visible in FIG. 12.

A transportable elevator system 2 that is arranged next to a mobile building 50, as it is depicted in FIG. 12, allows for conveniently transporting persons and/or objects between the plurality of floors of the mobile building 50.

In case the mobile building 50 is dismantled, for example for being moved to another site, the transportable elevator system 2 may be separated from the containers 52 and moved to another site together with or separately from the containers 52.

Consequently, a transportable elevator system 2 according to an exemplary embodiment of the invention may be used efficiently at a plurality of different installation sites.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, the invention is not intended to be limited to the specific embodiments disclosed, but to encompass all embodiments within the scope of the appended claims.

What is claimed is:

1. Transportable elevator system (2) comprising:
a hoistway (4) that comprises
a plurality of hoistway walls (24), wherein each hoistway wall (24) comprises at least one frame (24a), which surrounds a wall portion (24b, 24c), or which is surrounded by a wall portion (24b, 24c) and
a plurality of reinforcement elements (26, 28a, 28b, 38) mounted to the hoistway walls (24), in particular to the wall portions (24b, 24c) and/or to the frames (24a) of the hoistway walls (24), such as to extend in a horizontal direction when the hoistway (4) is oriented in an upright position;
an elevator car (6) that is configured for moving along the hoistway (4); and
an elevator machine (9) that is configured for driving the elevator car (6);
wherein the elevator car (6) and the elevator machine (9) are installed in the hoistway (4) forming an integrated elevator system (2) that is transportable to a desired installation site.

2. Transportable elevator system (2) according to claim 1, wherein the frame (24a) is made from a different material than the wall portion (24b, 24c).

3. Transportable elevator system (2) according to claim 1, wherein the wall portion (24b, 24c) is at least partially made of metal, in particular of corrugated metal, or of a synthetic material, in particular of a transparent and/or decorative synthetic material, such as acrylic glass or of wood.

4. Transportable elevator system (2) according to claim 1,
wherein the wall portion (24b, 24c) has an internal structure for enhancing the stability of the wall portion (24b, 24c);
wherein the wall portion (24b, 24c) comprises in particular an inner wall (25a, 27a) facing the interior of the hoistway (4), an outer wall (25b, 27b) facing to the outside of the hoistway (4), and at least one stabilizing structure that is arranged between the inner wall (25a, 27a) and the outer wall (25b, 27b).

5. Transportable elevator system (2) according to claim 4,
wherein the at least one stabilizing structure includes at least one undulated element (25c) that undulates between the inner wall (25a, 27a) and the outer wall (25b, 27b) of the wall portion (24b, 24c); and/or
wherein the at least one stabilizing structure comprises at least one stabilizing element (27c) that extends perpendicularly to the inner wall (25a, 27a) and to the outer wall (25b, 27b) of the wall portion (24b, 24c).

6. Transportable elevator system (2) according to claim 1, wherein the reinforcement elements (26, 28a, 28b, 29, 38) comprise at least one inner reinforcement element (26, 28a, 28b, 38) located on a side of a hoistway wall (24) facing the hoistway (4) and at least one corresponding outer reinforcement element (29) located on an opposite side of the hoistway wall (24) facing outside of the hoistway (4) and supporting the corresponding inner reinforcement element (26, 28a, 28b, 29, 38),
wherein the at least one of the outer reinforcement element (29) is mounted to the frame (24a) and/or to a wall portion (24b, 24c) of the hoistway wall (24b), and/or
wherein the at least one of the outer reinforcement element (29) extends in particular between two vertically extending beams of the frame (24a).

7. Transportable elevator system (2) according to claim 1, wherein the plurality of reinforcement elements (26, 28a, 28b, 38) comprises at least one reinforcement element (38) that is formed integrally with one of the frames, and/or
wherein the plurality of reinforcement elements (26, 28a, 28b, 38) comprises at least one reinforcement element (26, 28a, 28b) that is mounted to at least one of the frames (24a).

8. Transportable elevator system (2) according to claim 1, further comprising:
a counterweight (16) that is configured for moving simultaneously and concurrently with the elevator car (6); and
at least one counterweight guide rail (22) that is configured for guiding the counterweight (16) along the hoistway (4)

9. Transportable elevator system (2) according to claim 1, wherein the elevator machine (9) is located on a bedplate (30) that is supported by at least one of the reinforcement elements (26, 28a, 28b, 38).

10. Transportable elevator system (2) according to claim 1, further comprising at least one securing element (34) that is configured for supporting and/or for securing the elevator car (6) and/or a counterweight (16) in the hoistway (4), when the hoistway (4) is oriented horizontally for transportation,
wherein the at least one securing element (34) is in particular mounted to at least one of the reinforcement elements (28a, 28b); and/or
wherein the at least one securing element (34) is in particular configured for being removed after the elevator car (6) has been installed at the installation site.

11. Transportable elevator system (2) according to claim 1, wherein the hoistway (4) is formed from a plurality of hoistway modules (41-45) that are stacked vertically on top of each other; and
wherein adjacent hoistway modules (41-45) are mechanically coupled with each other by coupling structures (36) formed at the interfaces of adjacent hoistway modules (41-45)
wherein all hoistway modules (41-45) have the same height (h);
wherein each of the hoistway modules (41-45) has a height (h) in the range of between 2.5 m and 3.0 m, more particular a height (h) in the range of between 2.6 m and 2.7 m.

12. Transportable elevator system (2) according to claim 11, further comprising an elevator drive module (47) housing the elevator machine (9); wherein the elevator drive module (47) has in particular a smaller height (h′) than the hoistway modules (41-45).

13. Transportable elevator system (2) according to claim 1, comprising a plurality of landing doors (10) formed in the hoistway walls (24); wherein all landing doors (10) are formed on the same side of the hoistway (4); or
wherein at least one of the landing doors (10) is formed on another side of the hoistway (4) than the other landing doors (10).

14. Use of a transportable elevator system (2) according to claim 1 in a mobile building (50), wherein the mobile building (50) comprises in particular a plurality of containers (52) with at least two of the plurality of containers (52) being stacked vertically on top of each other.

15. Method of installing a transportable elevator system (2) according claim 1, wherein the method includes:
assembling the transportable elevator system (2), in particular in a factory;
transporting the transportable elevator system (2) to a installation site in a basically horizontal orientation;
erecting the transportable elevator system (2) at the installation site into a vertical orientation; and
mechanically coupling the transportable elevator system (2) with a building (50) at the installation site,
wherein the method in particular includes removing at least one securing element (34) that is configured for supporting and/or securing the elevator car (6) and/or the counterweight in the hoistway (4) when the hoistway (4) is oriented horizontally for transportation.
